(19) United States
(12) Patent Application Publication
(10) Pub. No.: US 2025/0378469 A1
(43) Pub. Date: Dec. 11, 2025

(54) ELECTRONIC APPARATUS AND CONTROL METHOD THEREFOR

(71) Applicant: SAMSUNG ELECTRONICS CO., LTD., Suwon-si (KR)

(72) Inventors: Donghwa JEONG, Suwon-si (KR); Sehyun KIM, Suwon-si (KR); Donguk KIM, Suwon-si (KR); Yeonwoo KIM, Suwon-si (KR); Jongin LEE, Suwon-si (KR)

(73) Assignee: SAMSUNG ELECTRONICS CO., LTD., Suwon-si (KR)

(21) Appl. No.: 19/310,524

(22) Filed: Aug. 26, 2025

Related U.S. Application Data
(63) Continuation of application No. PCT/KR2024/001057, filed on Jan. 23, 2024.

(30) Foreign Application Priority Data
Mar. 6, 2023 (KR) 10-2023-0029478
Aug. 4, 2023 (KR) 10-2023-0102349

(51) Int. Cl. G06Q 30/0272

(52) U.S. Cl. CPC G06Q 30/0272

(57) ABSTRACT

An electronic apparatus comprising a communication device to communicate with an external device; a memory; and at least one processor to acquire information about advertising content through the communication device and store, in the memory, the advertising content corresponding to the information. The at least one processor sets a preset time at which an operating state of the electronic apparatus is switched to update advertising content based on an expiration time of the advertising content and the operating mode of the electronic apparatus being switched to a power saving mode.

### CROSS-REFERENCE TO RELATED APPLICATION

This application is a continuation application, under 35 U.S.C. § 111 (a), of international application No. PCT/KR2024/001057, filed Jan. 23, 2024, which claims priority under 35 U. S. C. § 119 to Korean Patent Application No. 10-2023-0029478, filed Mar. 6, 2023, and Korean Patent Application No. 10-2023-0102349, filed Aug. 4, 2023, the disclosures of which are incorporated herein by reference in their entireties.

### TECHNICAL FIELD

The present disclosure relates to an electronic apparatus and a control method therefor, and more particularly, to an electronic apparatus capable of providing an advertisement by updating advertising content before an advertisement completion time, and a control method therefor.

### BACKGROUND ART

The electronic apparatus may perform an operation for generating and displaying an image or the like, or providing an image to a display device that displays an image. As described above, the electronic apparatus may display not only specific content selected by a user but also various information.

In particular, recent electronic apparatuses may also display various advertisements. Here, the advertisement may refer to an activity in which a company, individual, or organization invests to inform about products, services, or the like and achieve an intended purpose. The advertisements have been recently applied to various media such as web services and application services in addition to traditional media such as broadcasting and newspapers.

### DISCLOSURE OF INVENTION

### Solution to Problem

According to an embodiment of the present disclosure, provided is an electronic apparatus including: a communication device configured to communicate with an external device; a memory; and at least one processor configured to acquire information related to advertising content via the communication device, and store, in the memory, the advertising content corresponding to the information.

The at least one processor may be configured to set a predetermined time at which an operating mode of the electronic apparatus is switched to update the advertising content, based on an expiration time of the advertising content included in the information and the operating mode of the electronic apparatus being switched to a power saving mode.

The at least one processor may be configured to receive new advertising content corresponding to new information received from a server and update the advertising content stored in the memory based on a time point having lapsed subsequent to the operating mode of the electronic apparatus being switched, and switch the operating mode of the electronic apparatus based on the advertising content being updated.

The at least one processor may be configured to switch the operating mode of the electronic apparatus based on the predetermined time having lapsed while the operating mode of the electronic apparatus is in the power saving mode.

The device may further include a microcomputer, wherein the operating mode of the electronic apparatus includes a normal mode in which each component of the electronic apparatus is powered, and the power saving mode in which the memory and the at least one processor are not powered and the microcomputer is powered, and the microcomputer switches the operating mode of the electronic apparatus based on the predetermined time while the electronic apparatus is in the power saving mode based on a time corresponding to the expiration time.

The power saving mode is a first power saving mode and the operating mode of the electronic apparatus may further include a second power saving mode in which the memory and the at least one processor are powered and the electronic apparatus operates at a lower power consumption level than in the normal mode, and the microcomputer may switch the operating mode of the electronic apparatus to the second power saving mode based on the predetermined time while the electronic apparatus is in the first power saving mode based on the time corresponding to the expiration time.

The at least one processor may be configured to set the predetermined time to switch the operating mode of the electronic apparatus to a time point that is earlier than the expiration time of the advertising content.

The memory may store a plurality of advertising content, and the at least one processor may be configured to set the predetermined time to a time point corresponding to an advertising content which has an earliest expiration time among the plurality of advertising content.

The memory may store usage time information of the electronic apparatus, and the at least one processor may be configured to set the predetermined time based on the expiration time of the advertising content being within an unused time period of the electronic apparatus based on the usage time information.

The at least one processor may be configured to generate a first image including the advertising content, generate a second image corresponding to broadcast content after displaying the first image including the advertising content, and acquire advertising information related to new advertising content while generating the second image corresponding to the broadcast content and update the advertising content stored in the memory.

The first image including the advertising content may be a home screen of the electronic apparatus, and the advertising content may be disposed in a predetermined advertising region of the home screen.

According to an embodiment of the present disclosure, provided is a control method for an electronic apparatus, the method including: acquiring information related to advertising content; storing the advertising content corresponding to the information; and setting a predetermined time at which an operating mode of the electronic apparatus is switched to update the advertising content based on an expiration time of the advertising content included in the information and the operating mode of the electronic apparatus being switched to a power saving mode.

The method may further include: receiving advertising content corresponding to new information received from a server and updating the prestored advertising content based on the operating mode of the electronic apparatus being switched after the time point elapses; and switching the operating mode of the electronic apparatus based on the advertising content being updated.

The method may further include switching the operating mode of the electronic apparatus based on the predetermined time having lapsed while the operating mode of the electronic apparatus is the power saving mode.

The operating mode of the electronic apparatus may include a normal mode in which each component of the electronic apparatus is powered, and a first power saving mode in which a memory and at least one processor are not powered and a microcomputer is powered, and in the switching, the operating mode of the electronic apparatus may be switched based on the predetermined time while in the first power saving mode based on a time corresponding to the expiration time.

The operating mode of the electronic apparatus may further include a second power saving mode in which the memory and the at least one processor are powered and the electronic apparatus operates at a lower power consumption level than in the normal mode, and in the switching, the operating mode of the electronic apparatus may be switched to the second power saving mode based on the predetermined time while in the first power saving mode based on the time corresponding to the expiration time.

In the setting of the predetermined time, the predetermined time for switching the operating mode of the electronic apparatus may be set to a time point that is earlier than the expiration time of the advertising content.

In the storing, the plurality of advertising content may be stored, and in the setting of the predetermined time, the predetermined time may be set to a time point corresponding to an advertising content having an earliest expiration time among the plurality of advertising content.

The method may further include storing usage time information of the electronic apparatus, and in the setting of the predetermined time, the predetermined time may be set based on the expiration time of the advertising content being within an unused time period of the electronic apparatus based on the usage time information.

The method may further include: generating a first image including the advertising content; generating a second image corresponding to broadcast content after displaying the first image including the advertising content; and acquiring advertising information related to new advertising content while generating the second image corresponding to the broadcast content and update the prestored advertising content.

According to an embodiment of the present disclosure, provided is a non-transitory computer-readable recording medium storing a program to execute a control method for an electronic apparatus. The control method may include acquiring information related to advertising content, storing the advertising content corresponding to the information, and setting a predetermined time at which an operating mode of the electronic apparatus is switched to update the advertising content based on an expiration time of the advertising content included in the information and the operating mode of the electronic apparatus being switched to a power saving mode.

### BRIEF DESCRIPTION OF DRAWINGS

The above or other aspects, features, or benefits of embodiments in the present disclosure will be more apparent by the description provided below with reference to the accompanying drawings, in which:

FIG. 1 is a diagram for describing an advertisement displaying operation according to an embodiment of the present disclosure;

FIG. 2 is a block diagram showing a configuration of an electronic apparatus according to an embodiment of the present disclosure;

FIG. 3 is a block diagram showing a configuration of the electronic apparatus according to an embodiment of the present disclosure;

FIG. 4 is a diagram for describing an update operation of the advertising content according to an embodiment of the present disclosure;

FIG. 5 is a diagram for describing an example of a screen including the advertising content according to an embodiment of the present disclosure;

FIG. 6 is a diagram for describing the update operation of the advertising content if an exposure time of the advertising content expires in a power saving mode according to an embodiment of the present disclosure;

FIG. 7 is a sequence diagram for describing the update operation of the advertising content according to an embodiment of the present disclosure;

FIG. 8 is a sequence diagram for describing the update operation of the advertising content in the power saving mode according to an embodiment of the present disclosure;

FIG. 9 is a diagram for describing an operation for setting a timer based on a user usage pattern according to an embodiment of the present disclosure;

FIG. 10 is a diagram for describing an operation for controlling the electronic apparatus based on information detected from a surrounding device according to an embodiment of the present disclosure;

FIG. 11 is a diagram for describing an operation for controlling the electronic apparatus by using a home server according to an embodiment of the present disclosure;

FIG. 12 is a flowchart for describing a control method for an electronic apparatus according to an embodiment of the present disclosure; and

FIG. 13 is a flowchart for describing a method for updating the advertising content according to an embodiment of the present disclosure.

### MODE FOR INVENTION

The present disclosure may be variously modified and have several embodiments, and specific embodiments of the present disclosure are thus illustrated in the accompanying drawings and described in detail in this specification. However, it should be understood that the scope of the present disclosure are not limited to specific embodiments, and include all modifications, equivalents, and alternatives according to an embodiment of the present disclosure. Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the present disclosure thorough and complete, and are provided to completely convey the spirit of the present disclosure to those skilled in the art.

Terms used in the present disclosure are used only to describe the specific embodiments rather than limit the scope of the present disclosure. A term of a singular number may include its plural number unless explicitly indicated otherwise in the context.

In the present disclosure, the expression such as “have”, “may have”, “include”, or “may include”, indicates the presence of a corresponding feature (for example, a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

On the other hand, if any component (for example, the first component) is mentioned to be “directly coupled with/to” or “directly connected to” another component (for example, the second component), it should be understood that yet another component (for example, the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform˜” together with another device or component. For example, a “processor configured (or set) to perform A, B, and C” may indicate a dedicated processor (for example, an embedded processor) that may perform the corresponding operations or a general-purpose processor (for example, a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by at least one processor except for a “module” or a “part” that needs to be implemented by specific hardware.

Operations performed by the modules, the programs, or other components according to various embodiments may be executed in a sequential manner, a parallel manner, an iterative manner, or a heuristic manner, at least some of the operations may be performed in a different order or be omitted, or other operations may be added.

Meanwhile, the various elements and areas in the drawings are schematically shown. Therefore, the spirit of the present disclosure is not limited by relative sizes or intervals shown in the accompanying drawings.

Meanwhile, an electronic apparatus according to the various embodiments of the present disclosure may include, for example, at least one of a smartphone, a tablet personal computer (PC), a desktop PC, a laptop PC, or a wearable device. The wearable device may include at least one of an accessory-type wearable device (for example, a watch, a ring, a bracelet, an anklet, a necklace, glasses, contact lenses, or a head-mounted device (HMD)), a textile or clothing-integrated wearable device (for example, an electronic clothing), a body-attached wearable device (for example, a skin pad or a tattoo), or a biologically implantable circuit.

In some embodiments, the electronic apparatus may include, for example, at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box (e.g., Samsung HomeSync™, AppleTV™, or Google TV™), a game console (e.g., Xbox™ or PlayStation™), an electronic dictionary, an electronic key, a camcorder, or an electronic picture frame. Meanwhile, among the electronic apparatuses described above, a device including a display may be referred to as a display device. Meanwhile, the electronic apparatus according to the present disclosure may be a set-top box or a PC that provides an image to the display device even without the display.

Hereinafter, an embodiment of the present disclosure is described in detail with reference to the accompanying drawings so that those skilled in the art to which the present disclosure pertains may easily practice the present disclosure.

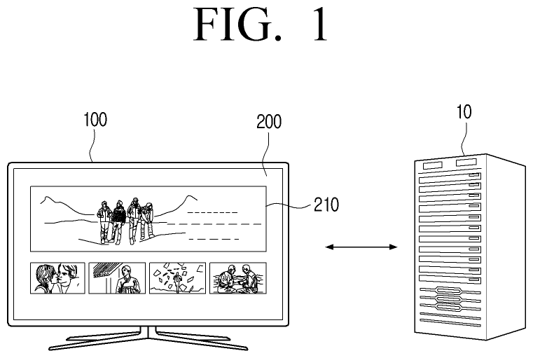

FIG. 1 is a diagram for describing an advertisement displaying operation according to an embodiment of the present disclosure.

Referring to FIG. 1, an electronic system may include an electronic apparatus 100 and a server 10. An illustrated example shows that the electronic system includes only one electronic apparatus and one server. However, in implementation, the electronic system may include a plurality of servers and a plurality of electronic apparatus. In addition, the illustrated example shows that the electronic apparatus 100 and the server 10 are directly connected to each other. However, in implementation, the electronic apparatus 100 and the server 10 may also be connected to each other via another device, such as a router.

The server 10 may manage an advertisement to be displayed on the electronic apparatus 100. In detail, the server 10 may manage advertising content to be displayed on the electronic apparatus 100, an inventory region where the advertising content is to be displayed, advertisement expiration time information, information about the number of exposures of the advertisement, or the like, and store the information about the advertising content (hereinafter, advertising information) accordingly.

Here, the inventory region may be information about a region where the advertisement is to be displayed, and may be information about a specific region of a home screen. The inventory region may also be referred to as an advertisement exposure region, an advertisement display region, or the like.

Accordingly, if the server 10 receives a request from the electronic apparatus 100 to provide new advertising information, the server 10 may provide one advertising information from among a plurality of advertising information to the electronic apparatus 100. Here, the server 10 may store advertising history information displayed on the electronic apparatus 100, and provide advertising information corresponding to an advertisement not displayed on the electronic apparatus 100 to the electronic apparatus 100 based on the advertising history information.

The electronic apparatus 100 may be a device that generates an image including the advertising content, and may be a device including a display, or a device that provides an image to the display device. For example, the electronic apparatus 100 may be a television (TV), a laptop, a portable multimedia player (PMP), a tablet PC, kiosk device, or the like that includes the display, or may be a set-top box that includes no display.

The electronic apparatus 100 may receive the advertising information from the server 10, and acquire and store the advertising content corresponding to the received advertising information. Here, the electronic apparatus 100 may acquire the advertising content from the server. For example, the advertising content may be included in the advertising information described above. Alternatively, the advertising information described above may include uniform resource locator (URL) information (or address information) that may be used to acquire the advertising content, and the electronic apparatus 100 may acquire the advertising content by accessing an URL address by using the URL information included in the advertising information.

In addition, the electronic apparatus 100 may display prestored advertising content. In detail, if the electronic apparatus 100 displays a screen 200 including a predetermined advertising region (or inventory) 210, the electronic apparatus 100 may include and display the advertising content prestored in the inventory.

Such a screen may be the home screen 200. However, in implementation, the screen may be applied not only to the home screen but also to any screen including a region where the advertisement may be displayed, such as an application execution screen.

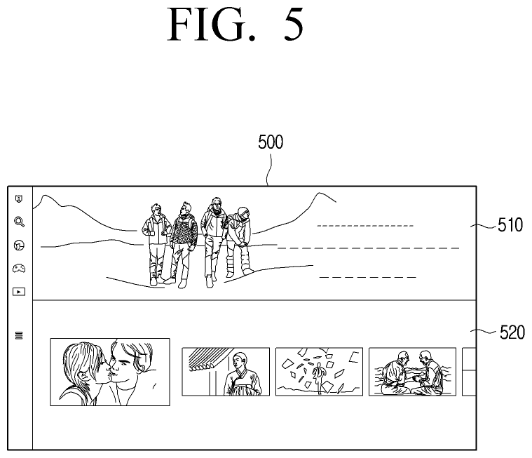

In addition, the home screen and the screen where the advertising content is displayed as described above may have a plurality of advertising regions, and each advertising region may have the same size or may have different sizes. The home screen is described below with reference to FIG. 5.

The electronic apparatus 100 may update the advertising content if the prestored advertising content is provided to the user or if an advertising period for displaying the advertising content ends.

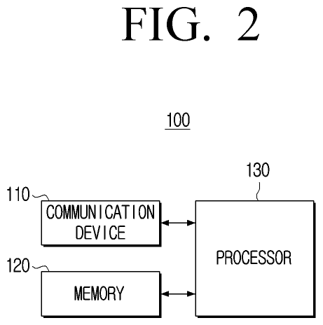

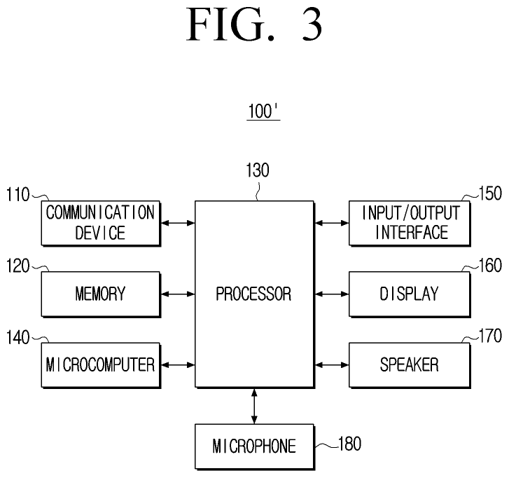

In detail, the electronic apparatus 100 may determine the advertising information of the stored advertising content to determine whether the stored advertising content may no longer be used, and may update the prestored advertising content based on a determination result. The specific configuration and operation of the electronic apparatus 100 for performing such an operation are described below with reference to FIG. 2 or 3.

Meanwhile, in providing the description with reference to FIG. 1, the electronic apparatus 100 is shown as directly displaying the advertising content. However, in implementation, the electronic apparatus 100 may generate an image including the advertising content, and the generated image may be displayed on a separate display device.

FIG. 2 is a block diagram showing a configuration of the electronic apparatus according to an embodiment of the present disclosure.

Referring to FIG. 2, the electronic apparatus 100 may include a communication device 110, a memory 120, and a processor 130.

The electronic apparatus 100 may have a plurality of operating modes. For example, the operating modes may include a first mode in which the electronic apparatus 100 may perform all of its normal operations, and a second mode in which the electronic apparatus 100 operates at a lower power consumption level than the first mode. Here, the operating mode may be referred to as an operation mode.

Here, the first mode may be a mode in which all components within the electronic apparatus 100 are powered and operated, and may be referred to as a general mode, or a normal mode, a general state, or a normal state.

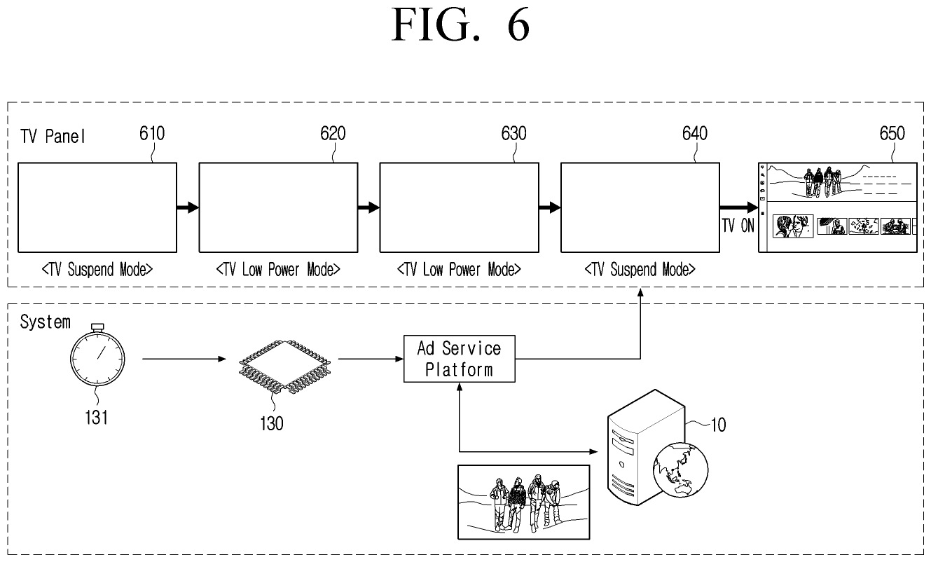

In addition, the second mode may be a mode in which the electronic apparatus 100 operates at the lower power consumption level than the first mode, where some components within the electronic apparatus 100 are not powered or some components within the electronic apparatus 100 are supplied with limited power. The second mode may be referred to as a power saving mode, a power saving state, or the like. Meanwhile, although the electronic apparatus 100 is described as including only two states above, the electronic apparatus 100 may have three or more modes in implementation. For example, the second mode described above may also be classified into a first power saving mode and a second power saving mode depending on a power consumption level. The operating modes of the electronic apparatus 100 are described in more detail with reference to FIG. 6.

The communication device 110 is a component for performing communication with various types of external devices by using various types of communication methods. The communication device 110 may include a wireless fidelity (Wi-Fi) module, a Bluetooth module, an infrared communication module, a wireless communication module, or the like. Here, each communication module may be implemented as at least one hardware chip.

The Wi-Fi module and the Bluetooth module may perform the communication in Wi-Fi and Bluetooth modes, respectively. If the Wi-Fi module or the Bluetooth module is used, the communication device 110 may first transmit and receive various connection information such as a service set identifier (SSID) or a session key, then establish the communication based on the connection information, and then transmit and receive various information.

The infrared communication module may perform the communication based on infrared data association (IrDA) technology that wirelessly transmits data in a short distance using an infrared ray between visible and millimeter waves.

In addition to the above-described communication methods, the wireless communication module may include at least one communication chip performing the communication based on various wireless communication standards such as Zigbee, third generation (3G), third generation partnership project (3GPP), long term evolution (LTE), LTE advanced (LTE-A), fourth generation (4G), and fifth generation (5G).

In addition, the communication device 110 may include at least one of wired communication modules that perform the communication by using a local area network (LAN) module, an Ethernet module, a pair cable, a coaxial cable, an optical fiber cable, or an ultrawideband (UWB) module.

An example, the communication device 110 may use the same communication module (for example, the Wi-Fi module) to communicate with the external device such as a remote control or an external server.

As another example, the communication device 110 may use a different communication module (for example, the Wi-Fi module) to communicate with the external device such as the remote control or the external server. For example, the communication device 110 may use at least one of the Ethernet module or the Wi-Fi module to communicate with the external server, and may also use the Bluetooth (BT) module to communicate with the external device such as a remote control. However, this configuration is only an embodiment, and the communication device 110 may use at least one of various communication modules in case of communicating with a plurality of external devices or a plurality of external servers.

The communication device 110 may receive the advertising information. In detail, the communication device 110 may request the new advertising information from the server, and receive the advertising information in response to the request. Here, the advertising information may include the address information for providing the advertising content, size information of the advertising content, the inventory information (or position information) indicating where the advertising content is to be displayed on the home screen, the advertisement expiration time information (or time information during which the advertisement may be displayed), the information about the number of exposures, or the like.

Here, the advertisement expiration time information may be information about a time at which the advertisement no longer needs to be exposed, and include only date information, or may include both date and time information. Here, the time may be information indicating a specific date or time point, or may be a relative value (for example, 24 hours from download).

In addition, the request for the new advertising information described above may include information corresponding to the prestored advertising information. In detail, if the advertising content corresponding to the prestored advertising information is exposed to the user (or if the corresponding advertisement is displayed), the communication device 110 may transmit information about the exposed advertising content to the server to perform the request for the new advertising information described above. Accordingly, the server 10 may store a history of advertisements displayed on the electronic apparatus 100, and based on the stored advertisement history, the server 10 may provide the new advertising information not displayed on the electronic apparatus 100.

In addition, the communication device 110 may receive the advertising content. In detail, the communication device 110 may receive the advertising content by using the address information included in the advertising information. The advertising content may be an image or a video. In this respect, the advertising content described above may be referred to as an advertising image, an advertising video, or the like, and may also be referred to using an expression such as promotional content or publicity content.

In addition, the communication device 110 may receive, from the external device, not only the advertising content but also information or content necessary for providing various applications and services of the electronic apparatus 100.

Meanwhile, the electronic apparatus 100 is required to perform an operation such as wake-up based on a control command from a remote control or the external device even in the power saving mode (or the second mode). Therefore, the communication device 110 needs to be operated not only in the normal mode but also in the power saving mode. Accordingly, the communication device 110 may be powered and operated not only in the first mode of the electronic apparatus 100 but also in the second mode thereof.

Meanwhile, if the communication device 110 includes a plurality of communication modules (for example, the Wi-Fi module and the infrared communication module), only some of the plurality of communication modules may be operated in the power saving mode.

The memory 120 may be implemented as an internal memory such as a read only memory (ROM) (for example, an electrically erasable programmable read-only memory (EEPROM)), a random access memory (RAM), or the like included in the processor 130, or may be implemented as a separate memory from the processor 130. In this case, the memory 120 may be implemented as a memory embedded in the electronic apparatus 100 or as a memory detachably attached to the electronic apparatus 100, based on a purpose of data storage. For example, data for operating the electronic apparatus 100 may be stored in the memory embedded in the electronic apparatus 100, and data for expanded functions of the electronic apparatus 100 may be stored in the memory detachably attached to the electronic apparatus 100.

The memory 120 may store the advertising content. In addition, the memory 120 may store the advertising information. Here, the memory 120 may store the received advertising content in a different position based on the operating mode of the electronic apparatus 100. In detail, if the electronic apparatus 100 is in the normal mode, the memory 120 may store the received advertising content in a volatile memory.

Meanwhile, the advertising content stored in the volatile memory may be transferred to a nonvolatile memory if the electronic apparatus 100 switches to a specific power saving mode in which the memory is not powered. Alternatively, the received advertising content may be stored directly in the nonvolatile memory if the electronic apparatus 100 temporarily switches its operating mode to store the advertising content for updating the advertising content while in the power saving mode, as described below.

In addition, the memory 120 may store the home screen and layout information included in the home screen. Here, the layout information may store information about a position of a predetermined advertising region included in the home screen, a size of the advertising region, or the like. The advertising region may be referred to as inventory. Meanwhile, a plurality of inventories may be included in the home screen. In this case, the memory 120 may store the plurality of advertising information and the plurality of advertising content. Here, the memory 120 may store the advertising content in a storage space corresponding to the inventory.

In addition, the memory 120 may store various contents (for example, broadcast contents or applications) received via the communication device 110 described above.

Meanwhile, the memory embedded in the electronic apparatus 100 may be implemented as at least one of a volatile memory (e.g., a dynamic random access memory (DRAM), a static RAM (SRAM), or a synchronous dynamic RAM (SDRAM)), or a non-volatile memory (e.g., an one time programmable read only memory (OTPROM), a programmable ROM (PROM), an erasable and programmable ROM (EPROM), an electrically erasable and programmable ROM (EEPROM), a mask ROM, or a flash ROM), a flash memory (e.g., a NAND flash or a NOR flash), a hard drive, or a solid state drive (SSD)). In addition, the memory detachably attached to the electronic apparatus 100 may be implemented as a memory card (e.g., a compact flash (CF), a secure digital (SD), a micro secure digital (Micro-SD), a mini secure digital (Mini-SD), an extreme digital (xD), or a multi-media card (MMC)), or an external memory which may be connected to a universal serial bus (USB) port (e.g., a USB memory).

In addition, the memory 120 may be operated selectively based on the operating mode of the electronic apparatus. For example, the memory 120 may be powered and operated in the normal mode, and may not be powered and operated in the power saving mode. Meanwhile, if the memory 120 is the volatile memory and if the operating mode of the electronic apparatus 100 is the power saving mode, although the memory 120 may be powered, the memory 120 may perform only a refresh operation, thereby being operated at the low power consumption level.

Meanwhile, the illustrated example shows that the electronic apparatus 100 includes one memory. However, if the volatile memory and the non-volatile memory are referred to separately, the electronic apparatus 100 may be regarded as including a plurality of memories.

The processor 130 may perform overall control operations of the electronic apparatus 100. In detail, the processor 130 may function to control overall operations of the electronic apparatus 100.

The processor 130 may be implemented as a digital signal processor (DSP), a microprocessor, a timing controller (TCON), each of which processes a digital signal. However, the processor 130 is not limited thereto, and may include at least one of a central processing unit (CPU), a micro controller unit (MCU), a micro processing unit (MPU), a controller, an application processor (AP), a graphics-processing unit (GPU), a communication processor (CP), an ARM processor, an artificial intelligence (AI) processor, or may be defined by a relevant term. In addition, the processor 130 may be implemented as a system-on-chip (SoC) or a large scale integration (LSI) that has a processing algorithm embedded therein, or may be implemented as a field programmable gate array (FPGA). The processor 130 may perform various functions by executing computer executable instructions stored in the memory. Meanwhile, FIG. 2 shows that the electronic apparatus 100 includes only one processor. However, in implementation, the electronic apparatus 100 may include a plurality of processors (for example, CPU+GPU or CPU+DSP).

The processor 130 may determine the operating mode of the electronic apparatus. For example, the processor 130 may determine the operating mode of the electronic apparatus 100 to be the power saving mode if there is no input from the user for a predetermined time, if a task is not performed for the predetermined time, or if a command to switch to the power saving mode is received from the user.

Although the above expression is used to describe determining the operating mode, the above expression may also interpreted as determining that the operating mode requires the switch to the power saving mode.

Alternatively, the processor 130 may temporarily switch to the normal mode (or another power saving mode) to update the advertising content through a process described below, and then determine the switch to the power saving mode if the advertising content update is completed.

Meanwhile, if the processor 130 receives a wake-up command from the user in the power saving mode or receives the wake-up command from the external device (for example, the remote control) via the communication device 110, the processor 130 may determine the operating mode of the electronic apparatus 100 as the normal mode.

In addition, the processor 130 may control each component of the electronic apparatus 100 to correspond to the determined operating mode. In detail, if the operating mode of the electronic apparatus 100 is switched to the power saving mode, the processor 130 may control each component of the electronic apparatus 100 to operate only a predetermined component.

In addition, the processor 130 may perform an operation corresponding to the switch in the operating mode of the electronic apparatus 100 described above. For example, the processor 130 may perform an operation such as setting a timer, which is to be described below, or transferring data stored in the volatile memory to the non-volatile memory.

The processor 130 may set a predetermined time for switching the operating mode of the electronic apparatus to update the advertising content at a time corresponding to an expiration time of the advertising content, based on the time information included in the information about the advertising content, if the operating mode of the electronic apparatus is switched to the power saving mode.

For example, if the processor 130 determines that a switch from the normal mode to the power saving mode is necessary, the processor 130 may set the timer to switch the operating mode of the electronic apparatus to update the advertising content at the time corresponding to the expiration time of the advertising content based on the time information included in the advertising information. Here, the timer may be a component for providing a notification upon the arrival of a specific time, and may be referred to as the predetermined time.

Meanwhile, if the plurality of inventories are included in the home screen, that is, if the electronic apparatus 100 stores the plurality of advertising content, the electronic apparatus 100 may set the timer (or the predetermined time) to a time corresponding to an advertisement having the earliest expiration time among the plurality of advertising content. In addition, if the plurality of advertising content is stored in one inventory, the timer (or the predetermined time) may be set to a time corresponding to an advertisement having the latest expiration time among the plurality of advertising content. In the addition, if the plurality of inventories exist and t plurality of advertising content may be stored in each of the plurality of inventories, the timer (or the predetermined time) may be set to a time corresponding to an advertisement having the earliest expiration time among the plurality of expiration time in each advertisements having the latest inventory.

Here, the processor 130 may set the timer (or the predetermined time) for switching the operating mode of the electronic apparatus to a time point that is the predetermined time earlier than the advertisement expiration time of the advertising content. For example, switching the operating mode and updating the advertisement of the electronic apparatus 100 require a certain amount of time, and the timer (or the predetermined time) described above may thus be set with a margin corresponding to that time or to a time set by a manufacturer.

Meanwhile, the timer is described above as being set based on the advertisement expiration time of the advertising content. However, in implementation, the timer (or the predetermined time) may be set by considering user history information. For example, if the advertisement expires at a time at which the user is expected to use the electronic apparatus 100, the timer setting described above may be omitted.

Conversely, the timer setting described above may be performed only if the advertisement expires at a time at which the user is expected not to use the electronic apparatus 100. In this case, the timer setting may be performed to update the advertisement at the time at which the user is expected to use the electronic apparatus, or a certain amount of time before the time described above, rather than at the advertisement expiration time of the advertising content.

The processor 130 may switch the operating mode of the electronic apparatus if the predetermined time elapses while the operating mode of the electronic apparatus is the power saving mode. For example, the processor 130 may determine the switch in the operating mode based on the timer while in the power saving mode. For example, if a current time elapses the time point set by the timer, the processor 130 may switch the operating mode of the electronic apparatus 100 to the normal mode (or the first mode), or to the power saving mode in which the advertising content may be updated. For this operation, the processor 130 may include multiple processor cores, and may use only one processor core to perform an operation for determining whether the current time elapses the time point set by the timer while in the power saving mode. Meanwhile, the determination of whether the set time elapses may be performed by a separate device other than the processor 130. An example of such a configuration is described below with reference to FIG. 3.

The processor 130 may receive advertising content corresponding to new information received from the server and update the advertising content stored in the memory 120 if the operating mode of the electronic apparatus is switched after the time corresponding to the expiration time of the advertising content elapses. For example, the processor 130 may control the communication device 110 to receive the new advertising information from the server if the operating mode is switched while in the power saving mode.

In addition, the processor 130 may control the communication device 110 to receive the advertising content based on the address information included in the new advertising information.

The processor 130 may switch the operating mode of the electronic apparatus if the advertising content is updated. In detail, the processor 130 may switch the operating mode of the electronic apparatus to the power saving mode (the first mode) again if the advertising content update is completed in a case where the operating mode of the electronic apparatus is switched for updating the advertising content.

The processor 130 may generate the home screen. In detail, the processor 130 may generate the home screen if the electronic apparatus 100 wakes up and receives, from the user, a control command such as displaying the home screen.

Here, the processor 130 may determine whether the advertising content is stored in the memory 120 and whether the advertising content may be displayed, and generate the home screen including the advertising content if a displayable advertising content is stored. Meanwhile, the processor 130 may generate the home screen including a default image (or default content) if the advertising content is not stored in the memory 120, or if the advertisement is expired although the advertising content is stored in the memory.

Meanwhile, the home screen may include a plurality of advertising regions, and the processor 130 may thus generate the home screen including the advertising content corresponding to each of the plurality of advertising regions. Here, the processor 130 may determine the expiration time of each advertising content, and generate the home screen including only the advertising content whose expiration time does not elapse. That is, if there is advertising content whose expiration time elapses, the processor 130 may generate the home screen including the default image (or default video) for the advertising region (or inventory) corresponding to the advertising content.

The processor 130 may determine whether the update of the prestored advertising content is required. In detail, the processor 130 may generate the home screen including the prestored advertising content and provide the same to the user, and if a screen other than the home screen is currently being displayed, the processor 130 may determine that the update of the advertising content stored in the memory 120 is required.

Alternatively, the processor 130 may determine that the update is required if the advertising content is determined to expire, even though the prestored advertising content is not displayed. Through this operation, the processor 130 may determine whether the advertising content expires by using the advertisement expiration time information in the advertising information corresponding to the advertising content stored in the memory.

If the update of the prestored advertising content is required, the processor 130 may request and receive the new advertising information from the server 10. Here, the processor 130 may control the communication device 110 to transmit the information about the prestored advertising content (i.e., information indicating that the advertising content is exposed) to the server 10. The above-described transmission of the information about the prestored advertising content may be performed in response to the request for the new advertising information, or may be performed as a separate transmission, distinguished from the above-described request.

Here, the advertising content update as described above may be performed simultaneously with another operation. For example, if a first image including the prestored advertising content is generated and displayed, and a second image corresponding to broadcast content is then generated and displayed based on a user selection, an operation for updating the prestored advertising content may be performed while generating the second image (or while displaying the second image).

Meanwhile, the update operation may be performed while the electronic apparatus 100 provides a screen other than the home screen. That is, while the electronic apparatus 100 displays a screen corresponding to the content selected by the user after displaying the home screen, the processor 130 may determine whether to update the prestored advertising content and perform the update operation described above if the update is required.

In addition, the processor 130 may receive the broadcast content and store the same in the memory 120 by using the address information included in the received advertising information. Here, the processor 130 may store the received broadcast content in a position corresponding to the inventory information (e.g., a memory address or a storage space address) based on the inventory information in the received advertising information.

As described above, the electronic apparatus according to the present disclosure may update (renew) the advertising content even if the electronic apparatus 100 enters the power saving mode, thereby preventing the advertising content from not being displayed due to the expiration of the prestored advertising content.

Meanwhile, only the brief configuration of the electronic apparatus 100 is shown and described above. However, in implementation, the electronic apparatus 100 may include various additional components. This configuration is described below with reference to FIG. 3.

FIG. 3 is a block diagram showing a configuration of the electronic apparatus according to an embodiment of the present disclosure.

Referring to FIG. 3, an electronic apparatus 100′ may include the communication device 110, the memory 120, the processor 130, a microcomputer 140, an input/output interface 150, a display 160, a speaker 170, and a microphone 180.

Hereinafter, the electronic apparatus 100′ is described as having three operating modes. However, in implementation, the electronic apparatus 100′ may have only two operating modes, as described with reference to FIG. 2.

First, the first mode is a mode in which all the components within the electronic apparatus 100 are powered. In detail, the memory 120 and the processor 130 may be powered, and this mode may be referred to as the general mode, the normal mode, the general state, the normal state, or the like.

The second mode is a mode in which some components within the electronic apparatus 100 are not powered. In detail, the memory 120, the processor 130, the input/output interface 150, the display 160, the speaker 170, and the microphone 180 are not powered, while only the communication device 110 and the microcomputer 140 are powered and operated. This mode may be referred to as the first power saving mode, a suspend mode, a sub-pendulum mode, a first power saving state, or the like.

A third mode is a mode in which some components within the electronic apparatus 100 are not powered, and may be a mode in which fewer components are powered than in the second mode. For example, the third mode may be a mode in which the memory 120 and the processor 130 are powered, while the display 160 is not powered. This mode may be referred to as the second power saving mode, a second power saving state, a low power mode, a low power state, or the like. In the third mode, a voice recognition operation for receiving a user voice may be performed, or an operation such as updating the advertising content as described above may be performed.

The configurations of the communication device 110, the memory 120, and the processor 130 are described above with reference to FIG. 2, and accordingly, only operations that differ from those shown in FIG. 2 are described below.

If the wake-up command is input from the external device while the electronic apparatus 100′ is in the power saving mode, the microcomputer 140 may perform the switch in the operating mode of the electronic apparatus 100 to the normal mode (or to a power saving mode different from a current power saving mode).

If the timer is set, the microcomputer 140 may compare the current time with the time (or time point) set by the timer to determine whether the current time elapses the time point set by the timer. To this end, the microcomputer 140 may store current time information and set time information in a register space (or the storage space). Meanwhile, only one time information is described above as being set by the timer. However, in implementation, the microcomputer 140 may set a plurality of timers, and an event that occurs if a set time of each timer arrives may be different.

Meanwhile, the microcomputer 140 is shown and described above as directly including timer information or determining whether the predetermined time elapses. However, the predetermined time or the like described above may be stored in a separate memory (or register), and the above-described determination operation may also be performed by a separate component that is distinguished from the microcomputer 140. In this case, the above-described separate component may be a component that is also operated in the power saving mode as described above.

In addition, as described with reference to FIG. 2, if the processor operates using the multiple processor cores, and one of the multiple processor cores is capable of operating even in the power saving mode, the above-described operation of the microcontroller may be performed by the processor core that also operates in the power saving mode described above.

The input/output interface 150 may be any one of a high definition multimedia interface (HDMI), a mobile high-a definition link (MHL), universal serial bus (USB), a DisplayPort (DP), Thunderbolt, a video graphics array (VGA) port, a red-green-blue (RGB) port, a D-subminiature (D-SUB), or a digital visual interface (DVI).

The input/output interface 150 may input/output at least one of audio or video signals. In some implementation examples, the input/output interface 150 may separately include a port for inputting/outputting only the audio signals and a port for inputting/outputting only the video signals, or may be implemented as a single port for inputting/outputting both the audio and video signals.

In addition, the input/output interface 150 may provide the video signal corresponding to a screen generated by the electronic apparatus 100′ or the audio signal together with the video signal to the external device (for example, the display device or the set-top box (STB)).

The display 160 may be implemented as any of various types of displays, such as a liquid crystal display (LCD), an organic light-emitting diode (OLED) display, or a plasma display panel (PDP). The display 160 may also include a driving circuit, a backlight unit, and the like, which may be implemented in a form such as a-si thin film transistor (TFT), a low temperature poly silicon (LTPS) TFT, or an organic TFT (OTFT). Meanwhile, the display 160 may be implemented as a touchscreen coupled with a touch sensor, a flexible display, a three-dimensional (3D) display, or the like.

The display 160 may display various images. For example, the display 160 may display the home screen or an image generated by the processor 130.

The speaker 170 may output sound. In detail, the speaker 170 may be a component that outputs various audio data processed through the input/output interface, as well as various notification sounds or voice messages. In addition, the speaker 170 may also output result information corresponding to the voice recognition operation described below.

In addition, the speaker 170 may output a notification sound corresponding to the switch in the operating mode of the electronic apparatus. For example, the speaker 170 may output the notification sound indicating that the switch is performed if the electronic apparatus 100′ switches from the power saving mode (the first power saving mode or the second power saving mode described above) to the normal mode.

The microphone 180 may receive the user voice in an activated state. For example, the microphone 180 may be integrated with the upper portion, front portion, side portion, or the like of the electronic apparatus 100. The microphone 180 include various components such as a microphone for may collecting the user voice in an analog form, an amplifier circuit for amplifying the collected user voice, an analog-to-digital (A/D) conversion circuit for sampling the amplified user voice and converting the same into a digital signal, and a filter circuit for removing noise components from the converted digital signal.

If the user voice is input through the microphone 180, the processor 130 may determine user voice content and perform an operation corresponding to the voice content. Meanwhile, although the user voice is described above as being input through the microphone 180, the microphone may be included in a remote control for controlling the electronic apparatus 100′, and the user voice input through the microphone included in the remote control may be input into the electronic apparatus 100′ through the communication device 110 described above and processed.

Meanwhile, if the electronic apparatus 100′ is in the power saving mode and the user voice is input through the remote control, the microcomputer 140 described above may determine a switch from the first power saving mode to the second power saving mode and process the user voice described above while in the second power saving mode. In addition, the processor 130 may switch the operating mode of the electronic apparatus 100′ from the second power saving mode to the normal mode if a command corresponding to the input user voice is determined to be the command to wake up the electronic apparatus 100′.

In addition, the electronic apparatus 100′ may operate not only based on the components or the remote control included in the electronic apparatus 100′, but also based on a control command from a user terminal device. For example, if the electronic apparatus is a TV or a set-top box, each manufacturer may recently provide an application for controlling the TV or the set-top box. Such an application may provide a function for enabling the user terminal device to be used as a remote control for the electronic apparatus.

Accordingly, if the user executes an application to control the TV or the set-top box by using the user terminal device, the user terminal device may transmit a signal to wake up the electronic apparatus 100′ or switch the electronic apparatus 100′ to the power saving mode in which at least the voice recognition operation may be performed.

The electronic apparatus 100′ that receives such a signal may switch from the first power saving mode to the second power saving mode. If the switch is performed, the electronic apparatus 100′ may determine an expiration period of the prestored broadcast content as described above and perform an update operation for the expired broadcast content.

Next, if the user inputs a voice command through the user terminal device, the electronic apparatus 100′ may perform the voice recognition operation and a corresponding voice recognition result by using a voice signal input through the user terminal device.

In addition, if the user inputs a turn-on command or the like through the user terminal device, the electronic apparatus 100′ may perform a corresponding control command based on the control command received through the user terminal device.

Meanwhile, the electronic apparatus 100 is described as including the display with reference to FIG. 3. However, if the electronic apparatus 100′ is a device such as a set-top box that includes no display, a display component may be omitted. In addition, depending on an implementation type, the speaker and the microphone described above may also be omitted. Furthermore, although not shown in FIG. 3, another component (for example, a camera or a human body detection sensor) may further be included.

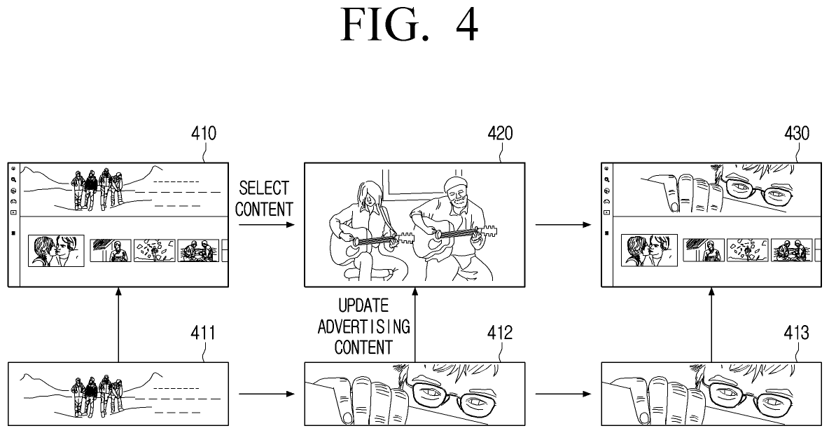

FIG. 4 is a diagram for describing the update operation of the advertising content according to an embodiment of the present disclosure.

Referring to FIG. 4, the electronic apparatus 100 may display a home screen 410. The home screen 410 may include a video (or an image) corresponding to prestored advertising content 411 and stored in the memory 120. Meanwhile, the illustrated example shows that the advertising content is displayed in a partial region of the home screen. However, in implementation, an entire screen may have only an image corresponding to the advertising content.

Next, if the user selects a specific application or a specific content, a second screen 420 including an image corresponding to the content selected by the user may be displayed. As shown in the drawing, a first screen and a second screen are different screens. The illustrated example shows that the second screen includes only an image corresponding to the broadcast content. However, the second screen may also display the broadcast content and additional information (for example, chat information, shopping information, or broadcast information) together.

In this way, if the first screen is switched to the second screen, the advertising content included in the first screen is already exposed to the user, thus requiring the update to the prestored advertising content. However, if new advertising content is to be acquired after the user inputs a command to switch to the home screen, it may be difficult to update the advertising content before the home screen is generated.

Accordingly, the electronic apparatus 100 may request and acquire the new advertising content from the server 10 if the prestored advertising content is already exposed while the second screen 420 is displayed, and store the acquired advertising content in the memory 120. Accordingly, advertising content 412 stored in the memory 120 may become different from existing content 411.

In this way, while the second screen 420 is displayed, the advertising content 412 may be updated and stored in the memory 120. Accordingly, if the user inputs the command to switch to the home screen, a home screen 430 including prestored advertising content 413 may be generated and displayed without delay. Through this operation, the electronic apparatus 100 may always expose a new advertisement whenever an opportunity to expose the advertisement arises.

Meanwhile, the illustrated example shows that the advertising content is always displayed. However, if the advertising content is not stored or the prestored advertising content is expired, the electronic apparatus 100 may display the home screen displaying the default image instead of the advertisement.

In addition, the electronic apparatus 100 may maintain the home screen that displays a current default image without reflecting the newly received advertising content, even if the new advertising content is received while the home screen exposes the default image. That is, the advertising content stored in the above-described state may be reflected the next time the home screen is displayed.

In detail, the user may feel uncomfortable if the advertisement or the default image displayed in the advertising region (i.e., inventory) is changed after the home screen is displayed. In this regard, the electronic apparatus according to the present disclosure may not change information in the inventory region of the home screen after the home screen is displayed to prevent the user from feeling uncomfortable.

Meanwhile, if the electronic apparatus 100 enters the power saving mode while displaying a specific broadcast content such as the screen 420, the memory 120 may be updated to store the new advertising content instead of the advertising content displayed on the existing home screen as described above.

If the electronic apparatus 100 wakes up before an expiration period of newly downloaded advertising content and displays the home screen, the electronic apparatus 100 use the prestored advertising content. However, if the user wakes up the electronic apparatus 100 after the expiration period of the prestored advertising content, the advertising content to be applied to the home screen to be displayed after the wake-up may have an expired display period.

In such a case, the electronic apparatus 100 may display the default content (or the default image) instead of the prestored advertising content as described above. However, such an operation may result in a loss of an opportunity to expose an advertisement. Accordingly, the electronic apparatus 100 in the present disclosure may perform an operation for setting the timer if the electronic apparatus 100 enters the power saving mode. This operation is described in more detail with reference to FIG. 6.

FIG. 5 is a diagram for describing an example of a screen including the advertising content according to an embodiment of the present disclosure.

Referring to FIG. 5, a home screen 500 may be a screen that may be displayed if the electronic apparatus is turned on or if a home screen command is input. The home screen may provide information (or thumbnails) about applications pre-installed on the electronic apparatus 100 and/or information (or thumbnails) recommended by each of the applications.

In addition, as shown in the drawing, the home screen 500 may include an inventory for displaying an advertisement. The inventories may include a plurality of regions 510 and 520.

For example, the first region 510 may be positioned in an upper portion of the screen, and the second region 520 may be positioned below the first region and have a smaller size than the first region.

In implementation, an advertisement displayed in the first region 510 and an advertisement displayed in the second region 520 may be advertisements of the same advertiser. In this case, advertising content displayed in the first region 510 and advertising content displayed in the second region 520 may be the same as each other. Alternatively, even if the advertisements are from the same advertiser, advertising content displayed in the first region 510 and advertising content displayed in the second region 520 may be different from each other. For example, the size, quality, or the like of the content may be different, and a type of the content may also be different. That is, the advertising content displayed in the first region 510 may be a video, and the advertising content displayed in the second region 520 may be an image.

Meanwhile, the illustrated example shows two inventories are displayed on one screen. However, in implementation, the home screen may include one inventory or three or more inventories.

In addition, the illustrated home screen is an example, and a home screen of a different form than the illustrated type may be applied. Furthermore, a layout of the home screen is not fixed, and may be changed based on an implementation process, or a provision from the manufacturer, or user customization.

Meanwhile, the present disclosure describes that the advertising content to be included in the inventory included in the home screen is not acquired and displayed in real time, but rather downloaded in advance and the prestored advertising content is displayed at the time the home screen is displayed. Such an operation for downloading the advertising content to be displayed in the inventory in advance may be referred to as Pre-Fetch.

Meanwhile, the illustrated example shows that the advertising content is displayed in a specific region (inventory) of the home screen. However, in implementation, the above-described operation may be applied to various cases where advertisements may be displayed, such as in a specific region of an application provided by the electronic apparatus 100 in addition to the home screen.

For example, the above-described operation may be applied to the advertising region if the electronic apparatus 100 is set to display a screen of the application that is performed immediately before, rather than the home screen in a case where the electronic apparatus 100 is turned on, and if the advertising region exists on the screen of the application.

FIG. 6 is a diagram for describing the update operation of the advertising content if an exposure time of the advertising content expires in the power saving mode according to an embodiment of the present disclosure.

Referring to FIG. 6, the electronic apparatus 100 may be in a first power saving mode 610. Here, the electronic apparatus 100 does not display an image in the first power saving mode. In addition, as described above, the timer is set, and the electronic apparatus 100 may determine whether the set time point is arrived, based on the timer. Here, the first power saving mode is a mode in which the processor and the memory are not powered and only some components such as the microcomputer are powered. This mode may be referred to as the suspend mode.

Next, if the current time elapses past the time point set by a timer 131, the microcomputer may switch the operating mode of the electronic apparatus 100 to the second power saving mode. That is, the microcomputer may control a power supply (not shown) to supply power to the processor and the memory.

In this way, if the electronic apparatus 100 switches to the second power saving mode (620), the processor 130 may update the advertising information and the advertising content while in the second power saving mode (630). The second power saving mode is a mode in which the electronic apparatus 100 operates at the lower power consumption level than in the normal mode although the processor and the memory are powered. This mode may be referred to as the low power mode.

In this way, the processor 130 may be powered in this second power saving mode, and the processor 130 may thus receive the advertising information from the server 10 and update the advertising content.

In addition, if the advertising information and advertising content update are completed, the processor 130 may switch the operating mode of the electronic apparatus back to the first power saving mode (640).

Next, if the user inputs a command to turn on the electronic apparatus 100, the microcomputer may switch the operating mode of the electronic apparatus to the normal mode based on the command.

Accordingly, the operating mode of the electronic apparatus 100 may switch to the normal mode, and the home screen including the prestored content may be displayed (650).

Meanwhile, the illustrated example shows that the electronic apparatus 100 switches to the first power saving mode immediately after the update of the advertising information. However, in implementation, a time point corresponding to the expiration point of the advertising information may be set by the timer before performing the switch, and the switch in the operating mode may then be performed.

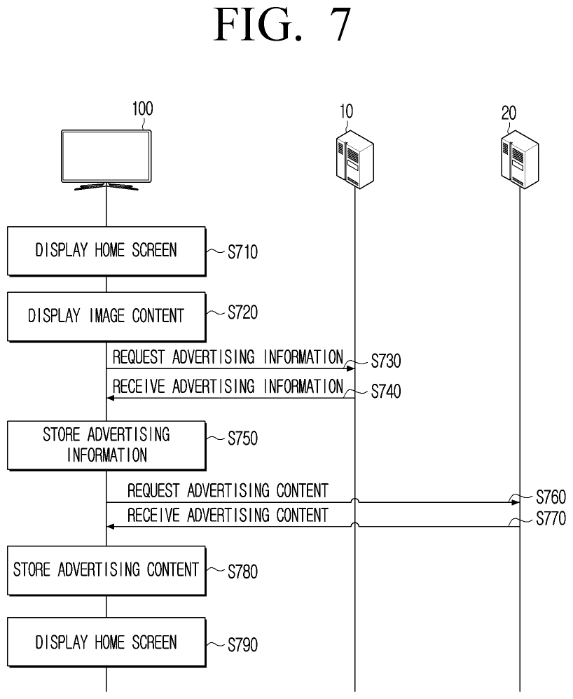

FIG. 7 is a sequence diagram for describing the update operation of the advertising content according to an embodiment of the present disclosure.

Referring to FIG. 7, the electronic system may include the electronic apparatus 100, a first server 10, and a second server 20.

Here, the first server 10 may be a server that stores the advertising information, and the second server 20 may be a server that stores the advertising content. The illustrated example describes that only two servers are included in the electronic system. However, in implementation, the plurality of second servers 20 may exist depending on a type of advertisement provided by the first server 10. In addition, the illustrated example shows and describes that the servers that provide the advertising information and the advertising content are separate from each other. However, in implementation, one server 10 may provide both the advertising information and the advertising content.

First, the electronic apparatus 100 may display the home screen (S710). Here, the home screen may be a screen including the prestored advertising content.

After displaying the home screen in this way, the electronic apparatus 100 may display an image corresponding to a specific broadcast (or content) based on a user control command (S720).

In this way, if the home screen is switched to another screen, an advertisement included in the home screen may be exposed to the user. Therefore, content for an advertisement to be displayed on the home screen next time may be requested if another advertisement is required to be displayed on the home screen next time.

Accordingly, the electronic apparatus 100 may request the advertising information from the first server 10 (S730). In response thereto, the first server 10 may provide the advertising information to the electronic apparatus 100 (S740). Here, the electronic apparatus 100 may provide information about the exposed advertisement to the server 10. Based on this provision, the server 10 may identify the advertisement used on the electronic apparatus 100, and may select the advertising information about an advertisement available on the electronic apparatus 100 (or the advertisement without a displayed/display history) among the stored advertising information (S750) and provide the same to the electronic apparatus 100.

The electronic apparatus 100 may acquire the advertising information, and acquire the advertising content based on the address information included in the advertising information. In detail, the electronic apparatus 100 may request the advertising content from the second server 20 corresponding to the address information and acquire the same (S760 and S770).

In this way, the electronic apparatus 100 may acquire a new advertisement and the advertising information and store the same in the memory (S780). Meanwhile, a storage address corresponding to a specific inventory of the home screen may exist, and the received advertising content may be stored in a storage address corresponding to an inventory position (or type) included in the advertising information. For example, if two advertising inventories are displayed on the home screen and the received advertising content is content corresponding to a first inventory, the received advertising content may be stored in a position corresponding to the first inventory.

If the user then inputs the command to switch to the home screen, the home screen including the new advertising content may be displayed (S790).

Meanwhile, a series of operations (S730 to S780) for acquiring the advertising information and the advertising content described above and storing the same in the memory may be performed while maintaining an operation for displaying image content. That is, the electronic apparatus 100 may perform the advertisement update described above in a background while performing the operation for displaying the image content.

Meanwhile, after displaying the home screen including the new advertising content, if the user inputs the command to switch the electronic apparatus to the power saving mode or if a separate command is not input for the predetermined time and the switch to the power saving mode is required, the electronic apparatus 100 may acquire the advertising content to be applied to the home screen if the electronic apparatus 100 switches from the power saving mode to the normal mode in the same manner as in a previous process, set the timer corresponding to the expiration information of the acquired advertising content, and then enter the power saving mode.

Meanwhile, the prestored advertising content has yet to be exposed if the user switches the electronic apparatus 100 to the power saving mode immediately while displaying the image content, that is, if step 790 is not performed in the illustrated example. Therefore, the electronic apparatus 100 may set the timer corresponding to the expiration time of the prestored advertising content and then perform the switch to the power saving mode rather than performing an operation for acquiring the new advertising content.

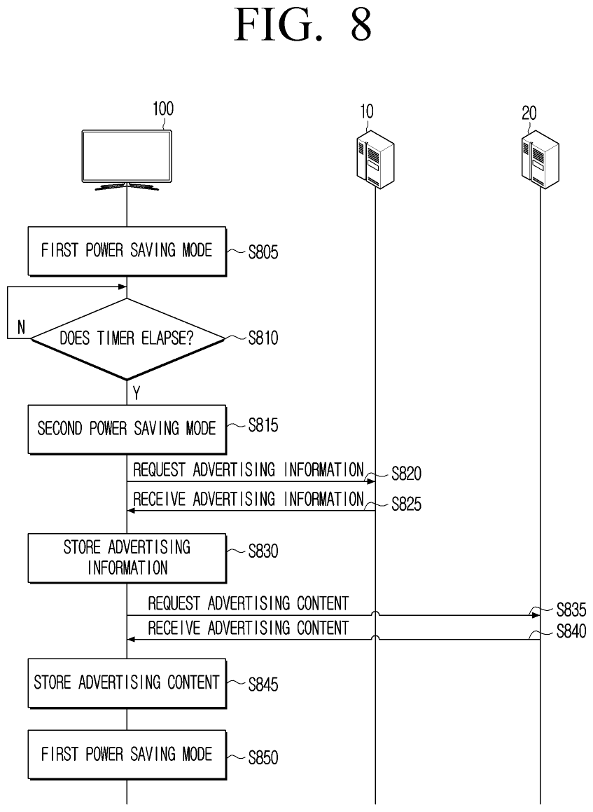

FIG. 8 is a sequence diagram for describing the update operation of the advertising content in the power saving mode according to an embodiment of the present disclosure.

Referring to FIG. 8, the electronic apparatus 100 may be in the power saving mode (S805). Here, the power saving mode may be a mode in which the CPU and the memory are not powered, and the microcomputer is operated. Only the microcomputer may be operated, and accordingly, less power may be consumed, and a user manipulation for the remote control or the like may be processed.

In addition, the timer may be set in the previous process and the electronic apparatus 100 may enter the power saving mode, the microcomputer may consecutively (or periodically) determine whether the current time elapses the time point set by the timer by using the set timer (S810). Here, if the turn-on command is input from the user or the wake-up command is input from another device, the microcomputer may switch the operating mode of the electronic apparatus from the power saving mode to the normal mode.

If the current time elapses a set time (S810-Y), the microcomputer may switch the operating mode of the electronic apparatus to the operating mode in which the electronic apparatus 100 may update the advertisement (S815). The illustrated example shows that although the processor and memory are powered, the electronic apparatus 100 switches to the second power saving mode in which the electronic apparatus 100 consumes less power than in the normal mode. However, in implementation, the electronic apparatus 100 may also be implemented to switch to the normal mode.

If the electronic apparatus 100 switches to the second power saving mode, the electronic apparatus 100 may request and receive the advertising information from the first server as described with reference to FIG. 7 (S820, S825 and S830), and acquire the advertising content based on the address information included in the advertising information (S835 and S840).

In addition, if the electronic apparatus 100 acquires the advertising content, the acquired advertising content may be stored in the memory (S845). In addition, if the advertising content is stored, the electronic apparatus 100 may switch to the first power saving mode again (S850).

As described above, the electronic apparatus 100 according to the present disclosure may perform the operation for updating the prestored advertising content if a display period (or the expiration time) of the prestored advertising content elapses in the power saving mode, thereby reducing a possibility in which the home screen does not including the advertising content is displayed.

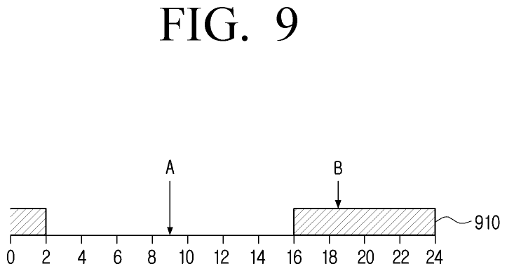

FIG. 9 is a diagram for describing an operation for setting the timer based on a user usage pattern according to an embodiment of the present disclosure.

Referring to FIG. 9, the electronic apparatus 100 may store user usage time information (910). For example, as shown in FIG. 9, the electronic apparatus 100 may be assumed as storing information that the user uses the electronic apparatus 100 from 16:00 to 24:00 and from 0:00 to 2:00.

Meanwhile, the illustrated example shows that the electronic apparatus 100 includes only one time information. However, the electronic apparatus 100 may include the time information for each day of the week. In addition, the time information described above may not simply be user usage history information, and may be learned information generated by learning the usage history information described above.

Meanwhile, the time information is shown and described above as the user usage history information. However, the user usage history information may also be expressed as operation time information of the electronic apparatus. In addition, a user usage history information above shows only information on whether the user uses the electronic apparatus 100 during a specific time (i.e., turning-on/off). However, the user usage time information may include information such as application information used during the specific time, whether a voice recognition function is used, a video on demand (VOD) usage pattern, and the like.

In this case, case A is described where an advertisement prestored on the electronic apparatus 100 expires at 9 o'clock.

First, if the user turns on and uses the electronic apparatus 100 at an expected time, i.e., 16:00, the currently stored advertising content may be completed and is thus unable to be provided to the user. Therefore, in this case, the electronic apparatus 100 may set the timer to update the advertisement at a time corresponding to a time at which the prestored advertisement expires.

Meanwhile, the electronic apparatus 100 is described as being implemented to update the advertising content in response to the expiration time of the prestored advertisement. However, as described above, if the electronic apparatus 100 acquires the user usage history information, the electronic apparatus 100 may set the timer to update the advertisement at the time the user is expected to use the electronic apparatus 100 or a certain time before that time.

Next, case B is described where an advertisement prestored on the electronic apparatus 100 expires at 18:00.

The prestored advertisement may expire at the time the user is expected to use the electronic apparatus 100, and accordingly, there is a high possibility that the advertisement is exposed during an expiration process. Therefore, if the prestored advertisement is expected to expire at the time the user is expected to use the electronic apparatus 100, the electronic apparatus 100 may switch to the power saving mode without setting the timer separately.

Meanwhile, it is assumed and described above that the prestored advertisement is updated at the expiration time of the advertisement to expose the prestored advertisement as much as possible. However, in implementation, the electronic apparatus 100 may also be implemented to update the prestored advertisement without setting the timer.

For example, the illustrated example describes that the timer may be set in an embodiment described above to update the advertisement that expires at time A if the current time is 2 o'clock and the operating mode of the electronic apparatus 100 is determined to enter the power saving mode. However, in the implementation, the timer may not be set, and the advertisement that expires at time A may be updated in advance with an advertisement that is completed after 16 o'clock immediately before the electronic apparatus 100 enters the power saving mode.

In addition, in implementation, the update operation described above may not be performed simply based on the time information, and may be implemented to perform the update (or the switch in the operating mode of the electronic apparatus) if various conditions are combined. For example, in the case shown in FIG. 9, the setting may be applied to switch the operating mode of the electronic apparatus if specific information is provided from another device after 15:00.

In detail, as described above, the user usage history information described above may correspond to the expectation, and to further enhance the expected information described above, the update operation described above may be performed in combination with information received from another device (for example, a manipulation of a living room light disposed in a living room, detection of a certain level of illuminance through an illuminance sensor, or pairing with the user terminal device).

Meanwhile, FIG. 9 shows that the user usage history information is used regardless of the content displayed on the electronic apparatus. However, in implementation, the electronic apparatus 100 may determine the content (or a program name) preferred by the user and generate the user usage history information described above by reflecting a broadcast schedule based on the preferred program, an electronic program guide (EPG), or the like.

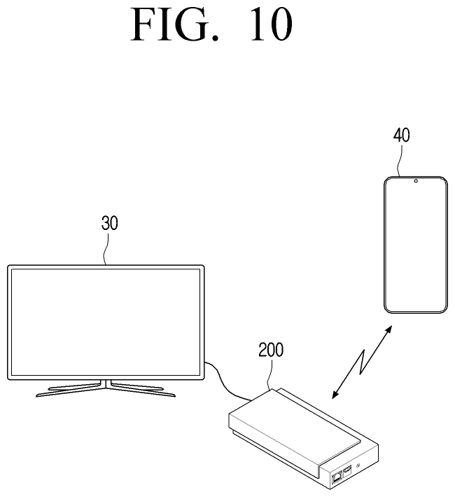

FIG. 10 is a diagram for describing an operation for controlling the electronic apparatus based on information detected from a surrounding device according to an embodiment of the present disclosure.

Referring to FIG. 10, an electronic apparatus 200 may store the advertising content, generate an image including the advertising content, and provide the same to a display device 30.

In addition, the electronic apparatus 200 may communicate with another electronic apparatus 40. Here, another electronic apparatus 40 may be the user terminal device, the illuminance sensor, an electronic apparatus providing a voice service, a device positioned to be adjacent to the electronic apparatus 200, an electronic apparatus carried by the user, or the like.

For example, if the electronic apparatus 200 is disposed in the living room of a home and the user enters the living room while/by holding his/her mobile phone 40, there is a high possibility in which the electronic apparatus 200 is operated. For example, if the electronic apparatus 200 is paired with the user terminal device 40 or receives information about an operating mode of the electronic apparatus disposed to be adjacent to the electronic apparatus 200 (for example, a sensor is activated, or a device providing the voice service is triggered by the user voice), the operating mode of the electronic apparatus 200 may be switched from the power saving mode to the normal mode, and the electronic apparatus 200 may determine whether the update of the prestored advertising content is required.

Meanwhile, the operation of the electronic apparatus 100 for switching its operating mode to update the advertisement or for identifying the update of the advertisement by utilizing the operation of the other device described with reference to FIG. 10 may be implemented by being coupled with the operation for setting the timer described above or the operation for setting the timer by considering the user usage history information described with reference to FIG. 9.

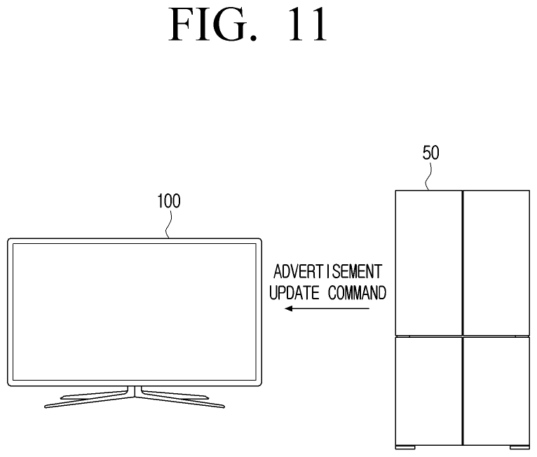

FIG. 11 is a diagram for describing an operation for controlling the electronic apparatus by using a home server according to an embodiment of the present disclosure.

Referring to FIG. 11, a home network may include the electronic apparatus 100 and a home server 50.

The home server 50 may be disposed within the home network and may be an always-on electronic apparatus such as a refrigerator, a home automation control panel, a security control panel, a media box (e.g., Samsung HomeSync™, AppleTV™, or Google TV™), or a network attached storage (NAS).

The home server 50 may acquire the advertising information stored by each of the electronic apparatuses 100 disposed within the home network, and manage the prestored advertising content for each electronic apparatus 100.

In detail, the home server 50 may determine the operating mode of the electronic apparatus 100 disposed within the home network, and if the operating mode of the electronic apparatus 100 is the power saving mode and the prestored advertising content of the electronic apparatus 100 expires (or expires before the predetermined time), the home server 50 may transmit the command to wake up the electronic apparatus 100 (wherein the wake up refers to the switch to the normal mode or the switch to the second power saving mode in which the advertising content may be updated).

To this end, the home server 50 may include the communication device for communicating with another device within the home network, the memory for storing the advertising information of the electronic apparatus 100 within the home network, the processor for determining the operating mode of the electronic apparatus 100 within the home network, and the processor for waking up the electronic apparatus if the operating mode of the electronic apparatus 100 is the power saving mode and the advertising content stored by the electronic apparatus 100 expires.

Meanwhile, a method for managing the advertisement of the electronic apparatus 100 by using the home server 50 shown in FIG. 11 may be a method that considers the user usage history described with reference to FIG. 9. However, the method may also be implemented by using information of another electronic apparatus described with reference to FIG. 10 or in combination with the operations shown in FIGS. 9 and 10.

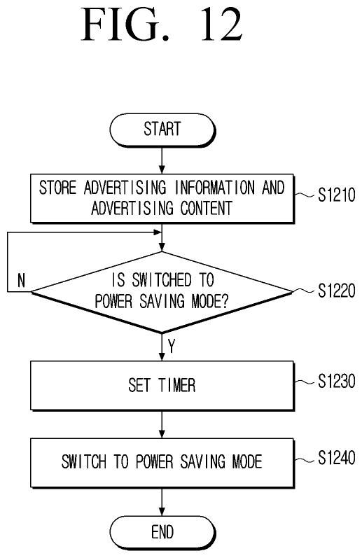

FIG. 12 is a flowchart for describing a control method for an electronic apparatus according to an embodiment of the present disclosure.

Referring to FIG. 12, the information about the advertising content and the advertising content corresponding to the information may be stored (S1210). In detail, the information about the advertising content may be acquired. For example, the electronic apparatus 100 may request the advertising information from the server providing the advertising information, and acquire the information about the advertising content (or the advertising information) in response to the above-described request. Here, the advertising information may include the address information providing the advertising content, the size information of the advertising content, the inventory information to be displayed on the home screen, the advertisement expiration time information, the information about the number of exposures, or the like.

In addition, the advertising content may be acquired and stored in the memory based on the address information included in the advertising information. Meanwhile, the illustrated example describes that the advertising information and the advertising content are acquired separately from separate servers or in separate steps. However, in implementation, the advertising content may be included in the advertising information and acquired through a single operation.

It may be determined whether the operating mode of the electronic apparatus is required to be switched to the power saving mode (S1220). In detail, it may be determined whether the switch in the operating mode of the electronic apparatus is required if the turn-off command of the electronic apparatus is input from the user, if an end time predetermined by the user arrives, if no control command for the electronic apparatus 100 is input for the predetermined time, or the like.

In addition, if the operating mode of the electronic apparatus is switched to the power saving mode, the predetermined time (or the timer) for the switch in the operating mode of the electronic apparatus may be set based on the time information included in the advertising information to update the advertising content at the time corresponding to the expiration time of the advertising content (S1230). Here, the timer may be set to the same time point as the advertisement expiration time of the advertising content, and the timer may be set to the time point that is the predetermined time (for example, 5 minutes to 10 minutes) earlier than the advertisement expiration time. The predetermined time may be arbitrarily set by the manufacturer in consideration of the performance and network conditions of the electronic apparatus 100.

Meanwhile, if the electronic apparatus 100 stores the plurality of advertising content, the electronic apparatus 100 may set the timer to the time point corresponding to the advertisement having the earliest expiration time among the plurality of advertising content. Here, the plurality of advertising content may be advertisements for different inventories. If the plurality of advertising content is stored in the same inventory, the timer may be set based on the expiration time of the advertising content having the latest advertisement expiration time for the same inventory.

Meanwhile, the above-described timer setting may also be performed based on the user usage time information. For example, there is no need to update the advertisement in advance f the advertisement expiration time of the prestored advertisement is a time period during which the user is expected to use the electronic apparatus. Accordingly, the above-described timer setting may be performed if the advertisement expiration time is a time period during which the user is expected not to use the electronic apparatus.

In addition, if the predetermined time (or the timer) is set, the operating mode of the electronic apparatus may be switched (S1240). For example, if the operating mode of the electronic apparatus includes only the normal mode and the power saving mode, the electronic apparatus may switch to the power saving mode.

Meanwhile, if the operating mode of the electronic apparatus 100 has the normal mode, the first power saving mode, and the second power saving mode, the electronic apparatus may switch from the normal mode to the first power saving mode. In addition, the update to the prestored advertising content may be performed by the electronic apparatus 100 switching from the first power saving mode to the second power saving mode after the above-described time point.

Meanwhile, only the operation for updating the advertising content in the power saving mode is described above. However, the advertising content may be updated if the prestored advertising content is exposed while the electronic apparatus operates in the normal mode, or if an exposure period of the advertising content expires.

For example, as described with reference to FIG. 4, the update to the prestored advertising content may be performed in parallel with the image display operation corresponding to the broadcast content described above while displaying the image corresponding to the broadcast content that is different from the corresponding image (or providing the image corresponding to the broadcast content to another external device) after displaying the image including the prestored advertising content.

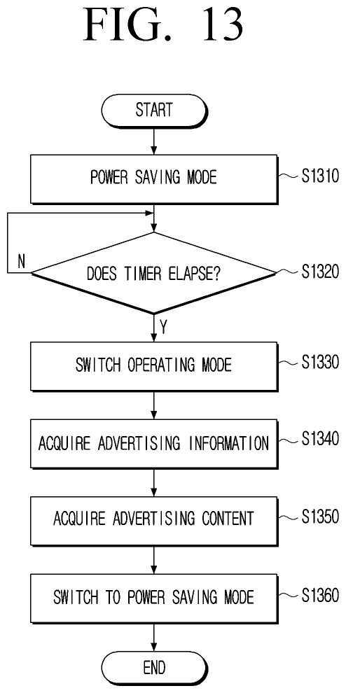

FIG. 13 is a flowchart for describing a method for updating the advertising content according to an embodiment of the present disclosure.

First, the electronic apparatus 100 may be in the power saving mode (S1310). For example, if the above-described state may be the power saving mode if the operating mode of the electronic apparatus 100 has only the normal mode and the power saving mode. If the operating mode of the electronic apparatus 100 has the normal mode, the first power saving mode, and the second power saving mode, the above-described state may be the first power saving mode in which the microcomputer is powered although the processor is not powered.

In addition, whether the predetermined time point elapses may be determined based on the set timer (S1320). In detail, the microcomputer may compare the set time point with the current time to determine whether the current time elapses the predetermined time point (or time). Here, the timer may also operate based on a counter value if operable based on the time information.

In addition, if the predetermined time point elapses, the operating mode of the electronic apparatus may be switched (S1330). For example, if the electronic apparatus has only two operating modes, the electronic apparatus may switch from the power saving mode to the normal mode. If the electronic apparatus has three operating modes, the electronic apparatus may switch from the first power saving mode to the second power saving mode.

If the operating mode of the electronic apparatus is switched, the electronic apparatus may a acquire the new advertising information (S1340). In detail, the electronic apparatus may request the new advertising information from an advertising server and receive the new advertising information from the server.

In addition, the electronic apparatus may acquire the advertising content corresponding to the new advertising information (S1350). In detail, the electronic apparatus may receive the new advertising information by using the address information included in the new advertising information, and store the received new advertising content in the memory.

In addition, if the advertising content is updated, the operating mode of the electronic apparatus may be switched (S1360).

Meanwhile, the methods according to at least some of the various embodiments of the present disclosure described above may be implemented in the form of an application capable of being installed on a conventional electronic apparatus.

In addition, the methods according to at least some of the various embodiments of the present disclosure described above may be implemented only by software upgrade or hardware upgrade of the conventional electronic apparatus.

In addition, the methods according to at least some of the various embodiments of the present disclosure described above may be performed through an embedded server disposed in the electronic apparatus, or at least one external server of the electronic apparatus.

Meanwhile, according to an embodiment of the present disclosure, the various embodiments described above may be implemented in software including an instruction stored in a machine-readable storage medium (for example, a computer-readable storage medium). A machine may be an apparatus that invokes the stored instruction from the storage medium, may be operated based on the invoked instruction, and may include the electronic apparatus (e.g., electronic apparatus A) according to the disclosed embodiments. If the instruction is executed by the processor, the processor may perform a function corresponding to the instruction directly or by using another component under control of the processor. The instruction may include a code provided or executed by a compiler or an interpreter. The machine-readable storage medium may be provided in the form of a non-transitory storage medium. Here, the “non-transitory storage medium” may refer to a tangible device and only indicate that this storage medium does not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored. According to an embodiment, the methods according to the various embodiments disclosed in the present disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store (e.g., PlayStore™) or directly between two user devices (e.g., smartphones). In case of the online distribution, at least a part of the computer program product (e.g., downloadable app) may be at least temporarily stored or temporarily provided in the machine-readable storage medium such as a server memory of a manufacturer, a server memory of an application store, or a relay server memory.

The various embodiments of the present disclosure may be implemented by software including an instruction stored in the machine-readable storage medium (for example, the computer-readable storage medium). A machine may be an apparatus that invokes the stored instruction from the storage medium, may be operated based on the invoked instruction, and may include the electronic apparatus (e.g., the electronic apparatus 100) according to the disclosed embodiments.

If the instruction is executed by the processor, the processor may directly perform a function corresponding to the instruction or other components may perform the function corresponding to the instruction under a control of the processor. The instruction may include a code provided or executed by a compiler or an interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic apparatus comprising:
a communication device configured to communicate with an external device;
a memory; and
at least one processor configured to:
acquire information related to advertising content via the communication device, and
store, in the memory, the advertising content corresponding to the information,
wherein the at least one processor is configured to set a predetermined time at which an operating mode of the electronic apparatus is switched to update the advertising content, based on an expiration time of the advertising content included in the information and the operating mode of the electronic apparatus being switched to a power saving mode.

2. The electronic apparatus as claimed in claim 1, wherein the at least one processor is configured to:
receive new advertising content corresponding to new information received from a server and update the advertising content stored in the memory based on a time point having lapsed subsequent to the operating mode of the electronic apparatus being switched, and
switch the operating mode of the electronic apparatus based on the advertising content being updated.

3. The electronic apparatus as claimed in claim 2,
wherein the at least one processor is configured to switch the operating mode of the electronic apparatus based on the predetermined time having lapsed while the operating mode of the electronic apparatus is in the power saving mode.

4. The electronic apparatus as claimed in claim 2, further comprising:
a microcomputer,
wherein the operating mode of the electronic apparatus includes:
a normal mode in which each component of the electronic apparatus is powered, and
the power saving mode in which the memory and the at least one processor are not powered and the microcomputer is powered, and
wherein the microcomputer switches the operating mode of the electronic apparatus based on the predetermined time while the electronic apparatus is in the power saving mode based on a time corresponding to the expiration time.

5. The electronic apparatus as claimed in claim 4, wherein the power saving mode is a first power saving mode and the operating mode of the electronic apparatus further includes:
a second power saving mode in which the memory and the at least one processor are powered and the electronic apparatus operates at a lower power consumption level than in the normal mode, and
wherein the microcomputer switches the operating mode of the electronic apparatus to the second power saving mode based on the predetermined time while the electronic apparatus is in the first power saving mode based on the time corresponding to the expiration time.

6. The electronic apparatus as claimed in claim 1, wherein the at least one processor is configured to set the predetermined time to switch the operating mode of the electronic apparatus to a time point that is earlier than the expiration time of the advertising content.

7. The electronic apparatus as claimed in claim 1, wherein the advertising content is among a plurality of advertising content stored in the memory, and
the at least one processor is configured to set the predetermined time to a time point corresponding to the advertising content which has an earliest expiration time among the plurality of advertising content.

8. The electronic apparatus as claimed in claim 1, wherein the memory stores usage time information of the electronic apparatus, and
the at least one processor is configured to set the predetermined time based on the expiration time of the advertising content being within an unused time period of the electronic apparatus based on the usage time information.

9. The electronic apparatus as claimed in claim 1, wherein the at least one processor is configured to:
generate a first image including the advertising content,
generate a second image corresponding to broadcast content after displaying the first image including the advertising content, and
acquire advertising information related to new advertising content while generating the second image corresponding to the broadcast content and update the advertising content stored in the memory.

10. The electronic apparatus as claimed in claim 9, wherein the first image including the advertising content is a home screen of the electronic apparatus, and
the advertising content is disposed in a predetermined advertising region of the home screen.

11. A method of controlling an electronic apparatus, the method comprising:
acquiring information related to advertising content;
storing the advertising content corresponding to the information; and
setting a predetermined time at which an operating mode of the electronic apparatus is switched to update the advertising content based on an expiration time of the advertising content included in the information, and the operating mode of the electronic apparatus being switched to a power saving mode.

12. The method as claimed in claim 11, further comprising:
receiving advertising content corresponding to new information received from a server and updating prestored advertising content based on the operating mode of the electronic apparatus being switched after a time point elapses; and
switching the operating mode of the electronic apparatus based on the advertising content being updated.

13. The method as claimed in claim 12, further comprising switching the operating mode of the electronic apparatus based on the predetermined time having lapsed while the operating mode of the electronic apparatus is the power saving mode.

14. The method as claimed in claim 13, wherein the operating mode of the electronic apparatus includes a normal mode in which each component of the electronic apparatus is powered, and
the power saving mode in which a memory and at least one processor are not powered and a microcomputer is powered, and
in the switching,
the operating mode of the electronic apparatus is switched based on the predetermined time while the electronic apparatus is in the power saving mode based on a time corresponding to the expiration time.

15. A non-transitory computer-readable recording medium storing a program to execute a control method of an electronic apparatus, wherein the control method comprising:
acquiring information related to advertising content,
storing the advertising content corresponding to the information, and
setting a predetermined time at which an operating mode of the electronic apparatus is switched to update the advertising content, based on an expiration time of the advertising content included in the information and the operating mode of the electronic apparatus being switched to a power saving mode.
